(19) United States
(12) Patent Application Publication
(10) Pub. No.: US 2014/0149828 A1
(43) Pub. Date: May 29, 2014

(54) SOLID STATE DRIVE AND JOINT ENCODING/DECODING METHOD THEREOF

(71) Applicant: LITE-ON IT CORPORATION, Taipei (TW)

(72) Inventors: Hsie-Chia Chang, Hsinchu (TW); Chi-Heng Yang, Hsinchu (TW); Shih-Jia Zeng, Hsinchu (TW)

(73) Assignee: LITE-ON IT CORPORATION, Taipei (TW)

(21) Appl. No.: 13/854,201

(22) Filed: Apr. 1, 2013

(30) Foreign Application Priority Data
Nov. 27, 2012 (CN) 201210493348.X

(51) Int. Cl. G06F 11/10

(52) U.S. Cl. CPC G06F 11/1068
USPC 714/773

(57) ABSTRACT

A joint encoding/decoding method for a solid state drive is provided. Firstly, a data-writing process is implemented for encoding a user data by a hard codec and a soft codec respectively, thereby generating a first number of parity bits and a second number of parity bits. Then, the user data, the first number of parity bits and the second number of parity bits are written into a flash memory module. Then, a data-reading process is implemented for decoding the user data by the hard codec according to the first number of parity bits. If the user data is successfully decoded, the user data is outputted. If the user data is unsuccessfully decoded, a step of decoding the user data by the soft codec according to the second number of parity bits is performed.

This application claims the benefit of People's Republic of China Application Serial No. 201210493348.X, filed Nov. 27, 2012, the subject matter of which is incorporated herein by reference.

### FIELD OF THE INVENTION

The present invention relates to a solid state drive and a controlling method thereof, and more particularly to a solid state drive and a joint encoding/decoding method thereof.

### BACKGROUND OF THE INVENTION

As is well known, the data storage devices using NAND-based flash memories are widely used in a variety of electronic devices. For example, a SD card or a solid state drive (SSD) is a data storage device that uses a NAND-based flash memory to store data. Generally, in the solid state drive or the related data storage device, a BCH code (Bose-Chaudhuri-Hocquenghem code) is used as an error correction code (ECC code) for facilitating increasing the reliability of the flash memory modules of the solid state drive.

Generally, the flash memory module of the solid state drive comprises plural cells. Each cell comprises a floating gate transistor. Depending on the data amount to be stored in the floating gate transistor, the flash memory modules may be classified into three types, i.e. a single-level cell (SLC) flash memory module, a multi-level cell (MLC) flash memory module and a triple-level cell (TLC) flash memory module. The SLC flash memory module can store only one bit of data per cell. The MLC flash memory module can store two bits of data per cell. The TLC flash memory module can store three bits of data per cell.

Moreover, the floating gate transistor of each cell has a floating gate to store hot carriers. A threshold voltage (V_{TH}) of the floating gate transistor is determined according to the amount of the stored hot carriers. If a floating gate transistor has a higher threshold voltage, it means that a higher gate voltage is required to turn on the floating gate transistor. Whereas, if a floating gate transistor has a lower threshold voltage, it means that the floating gate transistor can be turned on by a lower gate voltage.

During a program cycle of the flash memory module, the threshold voltage of the floating gate transistor may be changed by controlling the amount of hot carriers to be injected into the floating gate. During a read cycle, a sensing circuit of the data storage device may judge the storing status of the floating gate transistor according to the threshold voltage of the floating gate transistor.

FIG. 1 schematically illustrates the threshold voltage distribution curves of a MLC flash memory module in different storing states. Each cell of the MLC flash memory module has four storing states E, A, B and C. Before the hot carriers are injected into the cell, the cell is in a storing state E (e.g. the logic state is 11). As the number of hot carriers injected into the cell is gradually increased, the cell is sequentially switched to the storing state A (e.g. the logic state is 10), the storing state B (e.g. the logic state is 00) and the storing state C (e.g. the logic state is 01). Moreover, the voltage level in the storing state C>the voltage level in the storing state B>the voltage level in the storing state A>the voltage level in the storing state E.

Similarly, even if many cells are in the same storing state, the threshold voltages of these cells are not all identical. That is, the threshold voltages of these cells are distributed in a specified distribution curve with a median threshold voltage. As shown in FIG. 1, the cells in the storing state E have a median threshold voltage V_{THE} (e.g. 0 V), the cells in the storing state A have a median threshold voltage V_{THA} (e.g. 10 V), the cells in the storing state B have a median threshold voltage V_{THB} (e.g. 20 V), and the cells in the storing state C have a median threshold voltage V_{THC} (e.g. 30 V). Consequently, according to the threshold voltage distribution curves and three slicing voltages Vs1, Vs2 and Vs3, the storing states of the cells of the MLC flash memory module can be distinguished.

However, since the threshold voltages of the cells with the same storing state are distributed in a threshold voltage distribution curve, the storing states of some cells may be erroneously judged. For example, since the threshold voltage of the area b under the threshold voltage distribution curve of the storing state B is higher than the third slicing voltage Vs3, the cells of the area b are erroneously judged to be in the storing state C. Similarly, since the threshold voltage of the area c under the threshold voltage distribution curve of the storing state C is lower than the third slicing voltage Vs3, the cells of the area c are erroneously judged to be in the storing state B.

By the method of encoding the BCH code, the erroneous storing states of the cells can be corrected during the read cycle. Recently, as the importance of the process shrink is gradually increased, the demand on the correcting capability of the ECC code becomes more stringent. Conventionally, for increasing the correcting capability, the mainstream BCH code needs a large number of parity bits. Under this circumstance, the cost of the layout area is increased.

For solving this drawback, a low-density parity check code (also referred as a LDPC code hereinafter) using soft information in decoding can achieve higher correcting capability at less number of parity bits.

FIG. 2 schematically illustrates the use of the soft information to increase the correcting capability about the threshold voltage distribution curves of the MLC flash memory module of FIG. 1. Similarly, the three slicing voltages Vs1, Vs2 and Vs3 are employed to distinguish the storing states of the cells. Moreover, the LDPC code can use the soft information to increase the correcting capability. For example, in addition to the three slicing voltages Vs1, Vs2 and Vs3, a first voltage range (Vs1−˜Vs1+), a second voltage range (Vs2−˜Vs2+) and a third voltage range (Vs3−˜Vs3+) are also provided.

Take the threshold voltage distribution curves of the cells in the storing state B and the storing state C for example. When the threshold voltage of the area b under the threshold voltage distribution curve of the storing state B is read, the data in the storing state C is not directly read. Whereas, a probability value is provided for performing the subsequent data-correcting process. For example, the probability value may be 70% of the occurrence of the storing state C.

Similarly, when the threshold voltage of the area c under the threshold voltage distribution curve of the storing state C is read, a probability value is provided for performing the subsequent data-correcting process. For example, the probability value may be 80% of the occurrence of the storing state B. From the above discussions, the probability value is the soft information. The cooperation of the soft information and the LDPC code may correct the data.

However, for acquiring the soft information, the read level of judging the threshold voltages of the cells should be increased and the data bandwidth should be broadened. Under this circumstance, the hardware cost will be increased.

### SUMMARY OF THE INVENTION

The present invention provides a solid state drive and a joint encoding/decoding method thereof. During a data-encoding process, a first encoder and a second encoder are used to generate two independent sets of parity bits. During a data-decoding process, the cyclic decoding characteristics of a first decoder and a second decoder are used to generate the accurate data.

A first embodiment of the present invention provides a joint encoding/decoding method for a solid state drive. The joint encoding/decoding method includes the following steps. Firstly, a data-writing process is implemented for encoding a user data by a hard codec and a soft codec respectively, thereby generating a first number of parity bits and a second number of parity bits. Then, the user data, the first number of parity bits and the second number of parity bits are written into a flash memory module. Then, a data-reading process is implemented for decoding the user data by the hard codec according to the first number of parity bits. If the user data is successfully decoded, the user data is outputted. If the user data is unsuccessfully decoded, the joint encoding/decoding method further includes a step of decoding the user data by the soft codec according to the second number of parity bits.

A second embodiment of the present invention provides a joint encoding/decoding method for a solid state drive. The joint encoding/decoding method includes the following steps. Firstly, a data-writing process is implemented for encoding a user data by a hard codec and a soft codec respectively, thereby generating a first number of parity bits and a second number of parity bits. Then, the user data, the first number of parity bits and the second number of parity bits are written into a flash memory module. Then, a data-reading process is implemented for decoding the user data by the soft codec according to the second number of parity bits. If the user data is successfully decoded, the user data is outputted. If the user data is unsuccessfully decoded, the joint encoding/decoding method further includes a step of decoding the user data by the hard codec according to the first number of parity bits.

A third embodiment of the present invention provides a solid state drive. The solid state drive includes plural flash memory modules and a memory controller. The memory controller is connected with the plural flash memory modules, and includes plural hard codecs correspond to the plural flash memory modules and a soft codec. A user data is encoded by one of the hard codecs and the soft codec of the memory controller to generate a first number of parity bits and a second number of parity bits respectively. The user data, the first number of parity bits and the second number of parity bits are written into a corresponding one of the plural flash memory modules. During a data-reading process, the memory controller selectively uses the corresponding hard codec to decode the user data according to the first number of parity bits and/or uses the soft codec to decode the user data according to the second number of parity bits.

A fourth embodiment of the present invention provides a joint encoding/decoding method for a solid state drive. The joint encoding/decoding method includes the following steps. Firstly, a data-writing process is implemented for encoding a user data by a first encoding method and a second encoding respectively, thereby generating a first number of parity bits and a second number of parity bits. Then, the user data, the first number of parity bits and the second number of parity bits are written into a flash memory module. Then, a data-reading process is implemented for decoding the user data according to the first number of parity bits. If the user data is successfully decoded, the user data is outputted. If the user data is unsuccessfully decoded, the joint encoding/decoding method further includes a step of decoding the user data according to the second number of parity bits.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) schematically illustrates the threshold voltage distribution curves of a MLC flash memory module in different storing states;

FIG. 2 (prior art) schematically illustrates the use of the soft information to increase the correcting capability about the threshold voltage distribution curves of the MLC flash memory module of FIG. 1;

FIG. 3 is a schematic functional block diagram illustrating a solid state drive according to an embodiment of the present invention;

FIG. 4A is a flowchart illustrating an encoding process of writing a data to a solid state drive according to an embodiment of the present invention;

FIG. 4B schematically illustrates the configuration of the user data encoded by the encoding process of FIG. 4A;

FIGS. 5A˜5D, which are flowcharts illustrating various implementation examples of a joint encoding/decoding method of the present invention; and

FIG. 6 schematically illustrates the relationship between the bit error rate (BER) and the signal-to-noise ratio (SNR) for a BCH decoder and a LDPC decoder.

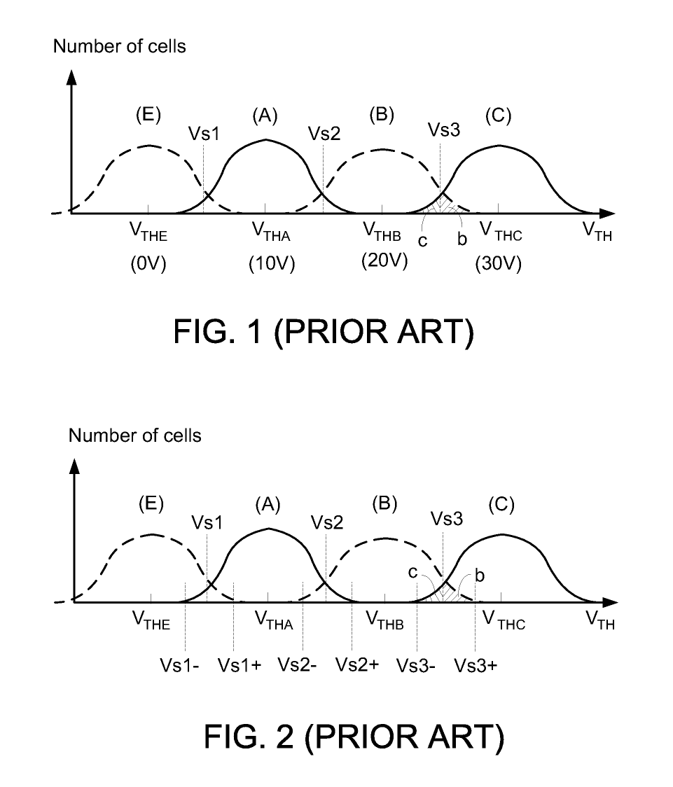

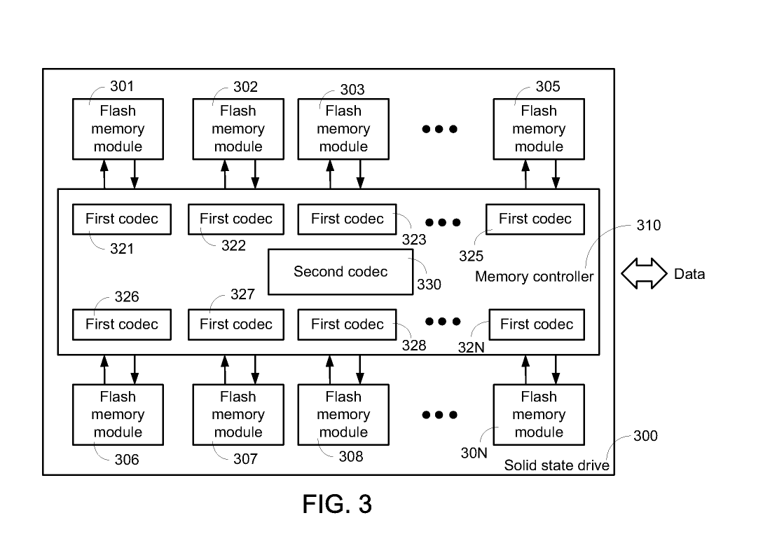

### DETAILED DESCRIPTION OF PREFERRED EMBODIMENTS

The present invention provides a solid state drive and a joint encoding/decoding method thereof.

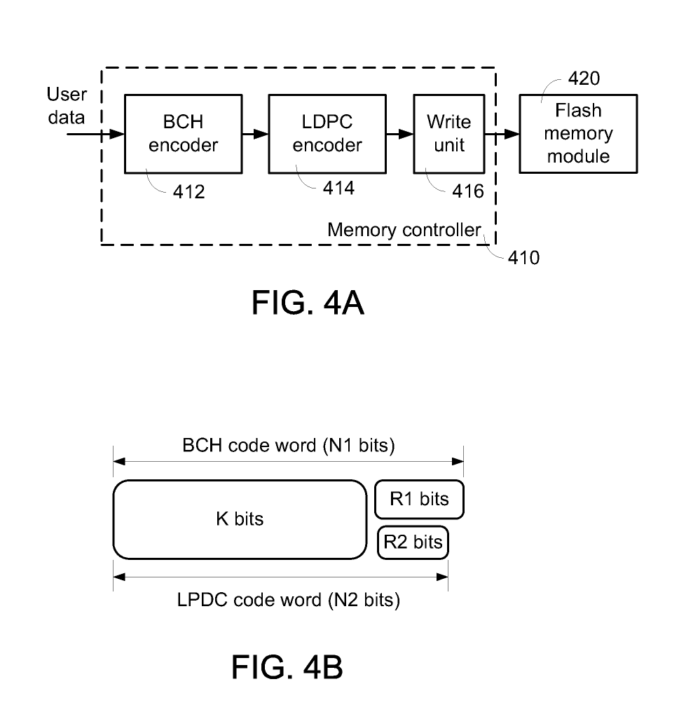

FIG. 3 is a schematic functional block diagram illustrating a solid state drive according to an embodiment of the present invention. As shown in FIG. 3, the solid state drive 300 comprises plural flash memory modules 301˜30N and a memory controller 310. The memory controller 310 comprises plural first codecs 321˜32N and a second codec 330. The plural first codecs 321˜32N are connected to corresponding flash memory modules 301˜30N, respectively. Generally, each of the first codecs 321˜32N and the second codec 330 comprises an encoder and a decoder.

In the memory controller 310, the plural first codecs 321˜32N are respectively used for processing the plural flash memory modules 301˜30N, and the second codec 330 is used for processing the whole system. In the following embodiments, the first codecs 321˜32N will be illustrated by referring to hard codecs (e.g. BCH codecs), and the second codec 330 will be illustrated by referring to a soft codec (e.g. a LDPC codec). It is noted that the types of the first codecs and the second codec may be varied according to practical requirements.

That is, the plural first codecs 321˜32N (i.e. the BCH codecs) of the memory controller 310 are respectively used for processing the plural flash memory modules 301˜30N, and the second codec 330 (i.e. the LDPC codec) of the memory controller 310 is used for processing the whole system. If the BCH codecs fail to correct all errors, the LDPC codec will further correct the errors. Moreover, if the LDPC codec results in an error floor effect, the cyclic decoding characteristics of the BCH codecs may be used to solve this drawback.

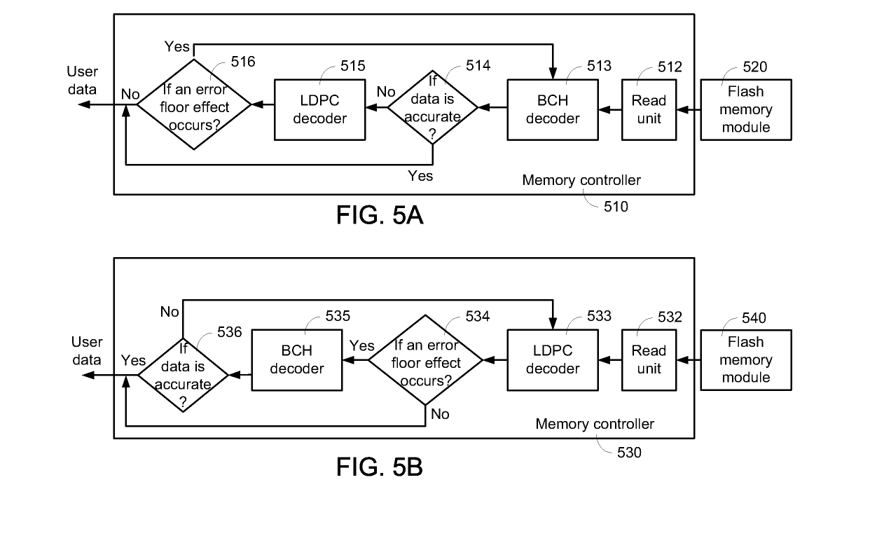

FIG. 4A is a flowchart illustrating an encoding process of writing a data to a solid state drive according to an embodiment of the present invention. For example, the first codec is a BCH codec, and the second codec is a LDPC codec. After a data is inputted into the memory controller 410, the data is encoded by a BCH encoder 412 of the BCH codec at a first time, and then the data is encoded by a LDPC encoder 414 of the LDPC codec at a second time. Then, the encoded data is written into the flash memory module 420 by a write unit 416 of the memory controller 410. Moreover, the above-mentioned data is a user data.

FIG. 4B schematically illustrates the configuration of the user data encoded by the encoding process of FIG. 4A. Before a K-bit user data is written from the external source to the flash memory module 420 through the memory controller 410, the user data is sequentially encoded by the BCH encoder 412 and the LDPC encoder 414. The K-bit user data is encoded into an N1-bit code by the BCH encoder 412, and then encoded into a N2-bit code by the LDPC encoder 414. After the K-bit user data is processed by the BCH encoder 412, additional R1 parity bits are created. After the K-bit user data is processed by the LDPC encoder 414, additional R2 parity bits are created. That is, N1=K+R1, and N2=K+R2. The BCH code word and the LDPC code word are independent of each other.

In this embodiment, since the first code (e.g. the BCH code) and the second code (e.g. the LDPC code) are independent of each other, the data-decoding process may be performed by a first decoder or a second decoder at first. Moreover, during the data-decoding process, associated judging operations are implemented by a judging unit (not shown) of the memory controller, which will be described later.

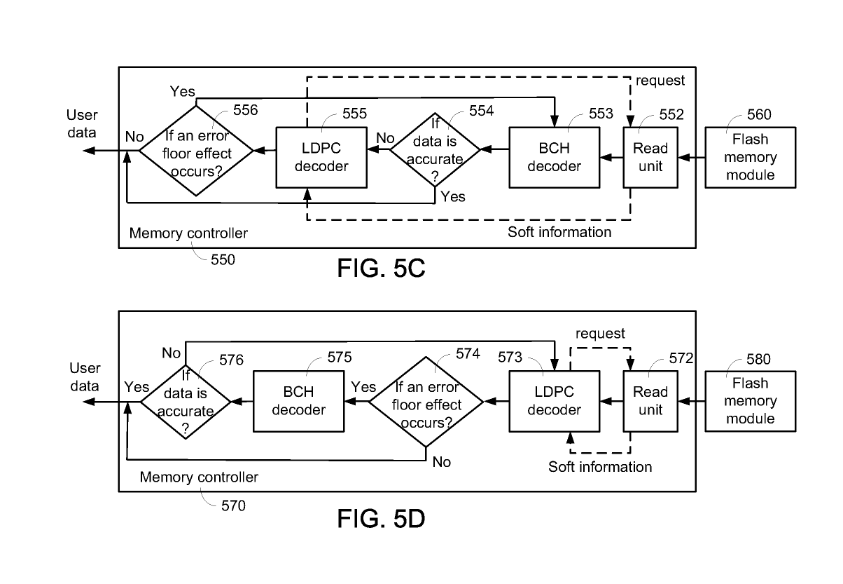

Please refer to FIGS. 5A˜5D, which are flowcharts illustrating various implementation examples of a joint encoding/decoding method of the present invention. In accordance with the present invention, the joint encoding/decoding method is used to accurately generate a K-bit user data. Hereinafter, for illustrating, the term “first code” denotes a BCH code, and the term “second code” denotes a LDPC code.

A first implementation example of the joint encoding/decoding method of the present invention is shown in FIG. 5A. As shown in FIG. 5A, the memory controller at least comprises a BCH decoder 513, a LDPC decoder 515 and a read unit 512. The BCH decoder of the BCH codec is used for decoding hard algebraic codes (e.g. BCH codes). The LDPC decoder of the LDPC codec is used for decoding soft probability codes (e.g. LDPC codes).

First of all, a N1-bit code is read from the flash memory module 520 by the read unit 512, wherein N1=K+R1. During the data-decoding process, the hard algebraic code decoder (e.g. the BCH decoder 513) is firstly used to decode the data according to the N1-bit code. If the K-bit user data is accurately generated (Step 514), the K-bit user data is directly outputted, and the data-decoding process is ended.

On the other hand, if the K-bit user data fails to be accurately generated (Step 514), it means that the number of erroneous bits contained in the read data exceeds the correcting range of the BCH decoder 513. Consequently, the BCH decoder 513 fails to generate the K-bit user data according to the N1-bit code. Next, a N2-bit code is read from the flash memory module 520 by the read unit 512, wherein N2=K+R2. The soft probability code decoder (e.g. the LDPC decoder 515) is used to decode the data according to the N2-bit code. If no error floor effect occurs (Step 516), it means that the K-bit user data can be accurately generated by the LDPC decoder 515. Consequently, the K-bit user data is directly outputted, and the data-decoding process is ended.

On the other hand, if the error floor effect occurs (Step 516), it means that the K-bit user data fails to be accurately generated by the LDPC decoder 515. Next, the initially-decoded K-bit user data generated by the LDPC decoder 515 is fed back to the BCH decoder 513, and further decoded by the BCH decoder 513 according to the R1 parity bits.

Although the K-bit user data fails to be accurately generated when the soft probability code decoder (e.g. the LDPC decoder 515) results in the error floor effect, the LDPC decoder 515 is still capable of correcting some of the erroneous bits and generating the initially-decoded K-bit user data. The number of erroneous bits contained in the initially-decoded K-bit user data is reduced or even decreased to the correcting range of the BCH decoder 513. Consequently, after the initially-decoded K-bit user data is fed back to the BCH decoder 513 and decoded by the BCH decoder 513 according to the R1 parity bits, the decoding capability of the BCH decoder 513 is enhanced.

In this implementation example, the soft probability code decoder (e.g. the LDPC decoder) decodes the soft probability code (e.g. the LDPC code) according to a hard-decision decoding method. However, the soft probability code decoder can decodes the soft probability code (e.g. the LDPC code) according to a soft-decision decoding method. The way of decoding the soft probability code by the soft-decision decoding method will be illustrated later.

Moreover, the soft probability code decoder may be used to decode data at first.

A second implementation example of the joint encoding/decoding method of the present invention is shown in FIG. 5B. First of all, a N2-bit code is read from the flash memory module 540 by a read unit 532, wherein N2=K+R2. The soft probability code decoder (e.g. a LDPC decoder 533) is used to decode the data according to the N2-bit code. If no error floor effect occurs (Step 534), it means that the K-bit user data can be accurately generated by the LDPC decoder 533. Consequently, the K-bit user data is directly outputted, and the data-decoding process is ended.

On the other hand, if the error floor effect occurs (Step 534), it means that the K-bit user data fails to be accurately generated by the LDPC decoder 533. Next, a N1-bit code is read from the flash memory module 540 by the read unit 532, wherein N1=K+R1. A hard algebraic code decoder (e.g. the BCH decoder 535) is used to decode the data according to the N1-bit code. If the K-bit user data is accurately generated (Step 536), the K-bit user data is directly outputted, and the data-decoding process is ended.

On the other hand, if the K-bit user data fails to be accurately generated (Step 536), it means that the BCH decoder 535 fails to generate the K-bit user data according to the N1-bit code. Next, the initially-decoded K-bit user data generated by the BCH decoder 535 is fed back to the LDPC decoder 533, and further decoded by the LDPC decoder 533 according to the R2 parity bits.

Although the hard algebraic code decoder (e.g. the BCH decoder 535) fails to generate the K-bit user data, the BCH decoder 535 is still capable of correcting some of the erroneous bits and generating the initially-decoded K-bit user data. The number of erroneous bits contained in the initially-decoded K-bit user data is reduced or even decreased to prevent from occurrence of the error floor effect. Consequently, after the initially-decoded K-bit user data is fed back to the LDPC decoder 533 and decoded by the LDPC decoder 533 according to the R2 parity bits, the decoding capability of the LDPC decoder 533 is enhanced.

In this implementation example, the soft probability code decoder (e.g. the LDPC decoder) decodes the soft probability code (e.g. the LDPC code) according to a hard-decision decoding method. However, the soft probability code decoder can decodes the soft probability code (e.g. the LDPC code) according to a soft-decision decoding method. The way of decoding the soft probability code by the soft-decision decoding method will be illustrated later.

A third implementation example of the joint encoding/decoding method of the present invention is shown in FIG. 5C. First of all, a N1-bit code is read from the flash memory module 560 by the read unit 552, wherein N1=K+R1. During the data-decoding process, the hard algebraic code decoder (e.g. the BCH decoder 553) is firstly used to decode the data according to the N1-bit code. If the K-bit user data is accurately generated (Step 554), the K-bit user data is directly outputted, and the data-decoding process is ended.

On the other hand, if the K-bit user data fails to be accurately generated (Step 554), it means that the number of erroneous bits contained in the read data exceeds the correcting range of the BCH decoder 553. Consequently, the BCH decoder 553 fails to generate the K-bit user data according to the N1-bit code. Next, a N2-bit code is read from the flash memory module 560 by the read unit 552, wherein N2=K+R2. The soft probability code decoder (e.g. the LDPC decoder 555) is used to decode the data according to the N2-bit code and a soft information. For example, in response to a request from the LDPC decoder 555, the read unit 552 generates the soft information to the LDPC decoder 555. Consequently, the LDPC decoder 555 decodes the soft probability code (e.g. the LDPC code) by the soft-decision decoding method.

If no error floor effect occurs (Step 556), it means that the K-bit user data can be accurately generated by the LDPC decoder 555. Consequently, the K-bit user data is directly outputted, and the data-decoding process is ended.

On the other hand, if the error floor effect occurs (Step 556), it means that the K-bit user data fails to be accurately generated by the LDPC decoder 555. Next, the initially-decoded K-bit user data generated by the LDPC decoder 555 is fed back to the BCH decoder 553, and further decoded by the BCH decoder 553 according to the R1parity bits.

Although the K-bit user data fails to be accurately generated when the soft probability code decoder (e.g. the LDPC decoder 555) results in the error floor effect, the LDPC decoder 555 is still capable of correcting some of the erroneous bits and generating the initially-decoded K-bit user data. The number of erroneous bits contained in the initially-decoded K-bit user data is reduced or even decreased to the correcting range of the BCH decoder 553. Consequently, after the initially-decoded K-bit user data is fed back to the BCH decoder 553 and decoded by the BCH decoder 553 according to the R1 parity bits, the decoding capability of the BCH decoder 553 is enhanced.

Moreover, the soft probability code decoder may be used to decode data at first.

A fourth implementation example of the joint encoding/decoding method of the present invention is shown in FIG. 5D. First of all, a N2-bit code is read from the flash memory module 580 by a read unit 572, wherein N2=K+R2. The soft probability code decoder (e.g. a LDPC decoder 573) is used to decode the data according to the N2-bit code and the soft information. For example, in response to a request from the LDPC decoder 573, the read unit 572 generates the soft information to the LDPC decoder 573. Consequently, the LDPC decoder 573 decodes the soft probability code (e.g. the LDPC code) by the soft-decision decoding method.

If no error floor effect occurs (Step 574), it means that the K-bit user data can be accurately generated by the LDPC decoder 573. Consequently, the K-bit user data is directly outputted, and the data-decoding process is ended.

On the other hand, if the error floor effect occurs (Step 574), it means that the K-bit user data fails to be accurately generated by the LDPC decoder 573. Next, a N1-bit code is read from the flash memory module 580 by the read unit 572, wherein N1=K+R1. A hard algebraic code decoder (e.g. the BCH decoder 575) is used to decode the data according to the N1-bit code. If the K-bit user data is accurately generated (Step 576), the K-bit user data is directly outputted, and the data-decoding process is ended.

On the other hand, if the K-bit user data fails to be accurately generated (Step 576), it means that the BCH decoder 575 fails to generate the K-bit user data according to the N1-bit code. Next, the initially-decoded K-bit user data generated by the BCH decoder 575 is fed back to the LDPC decoder 573, and further decoded by the LDPC decoder 573 according to the R2 parity bits.

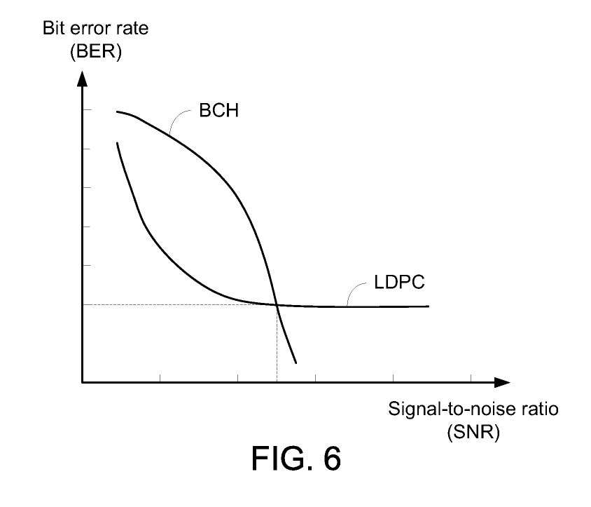

FIG. 6 schematically illustrates the relationship between the bit error rate (BER) and the signal-to-noise ratio (SNR) for a BCH decoder and a LDPC decoder. As shown in FIG. 6, if the signal-to-noise ratio is very low, the LDPC decoder has better correcting capability (i.e. lower bit error rate) than the BCH decoder. As the signal-to-noise ratio is increased to a specified value, the BCH decoder has better correcting capability than the LDPC decoder. Moreover, as the signal-to-noise ratio is continuously increased, the bit error rate of the BCH decoder is continuously decreased. Moreover, after the signal-to-noise ratio is increased to the specified value, the bit error rate fails to be continuously decreased by the LDPC decoder, which indicates the occurrence of the error floor effect.

From the above descriptions, the present invention provides a solid state drive and a joint encoding/decoding method thereof. During a data-encoding process, a first encoder and a second encoder are used to generate two independent sets of parity bits. During a data-decoding process, the cyclic decoding characteristics of a first decoder and a second decoder are used to generate the accurate data.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A joint encoding/decoding method for a solid state drive, the joint encoding/decoding method comprising steps of:
implementing a data-writing process for encoding a user data by a hard codec and a soft codec respectively, thereby generating a first number of parity bits and a second number of parity bits;
writing the user data, the first number of parity bits and the second number of parity bits into a flash memory module; and
implementing a data-reading process for decoding the user data by the hard codec according to the first number of parity bits, wherein if the user data is successfully decoded, the user data is outputted, wherein if the user data is unsuccessfully decoded, the joint encoding/decoding method further comprises a step of decoding the user data by the soft codec according to the second number of parity bits.

2. The joint encoding/decoding method as claimed in claim 1, wherein after the step of decoding the user data by the soft codec according to the second number of parity bits is performed, the joint encoding/decoding method further comprises steps of:
if the user data is successfully decoded, outputting the user data; and
if the user data is unsuccessfully decoded, generating an initially-decoded user data, and then decoding the user data by the hard codec according to the initially-decoded user data and the first number of parity bits.

3. The joint encoding/decoding method as claimed in claim 1, wherein the hard codec is a BCH codec.

4. The joint encoding/decoding method as claimed in claim 1, wherein the soft codec is a LDPC codec.

5. The joint encoding/decoding method as claimed in claim 1, wherein the user data is decoded by the soft codec according to a hard-decision decoding method.

6. The joint encoding/decoding method as claimed in claim 1, wherein the user data is decoded by the soft codec according to a soft-decision decoding method.

7. A joint encoding/decoding method for a solid state drive, the joint encoding/decoding method comprising steps of:
implementing a data-writing process for encoding a user data by a hard codec and a soft codec respectively, thereby generating a first number of parity bits and a second number of parity bits;
writing the user data, the first number of parity bits and the second number of parity bits into a flash memory module; and
implementing a data-reading process for decoding the user data by the soft codec according to the second number of parity bits, wherein if the user data is successfully decoded, the user data is outputted, wherein if the user data is unsuccessfully decoded, the joint encoding/decoding method further comprises a step of decoding the user data by the hard codec according to the first number of parity bits.

8. The joint encoding/decoding method as claimed in claim 7, wherein after the step of decoding the user data by the hard codec according to the first number of parity bits, the joint encoding/decoding method further comprises steps of:
if the user data is successfully decoded, outputting the user data; and
if the user data is unsuccessfully decoded, generating an initially-decoded user data, and then decoding the user data by the soft codec according to the initially-decoded user data and the second number of parity bits.

9. The joint encoding/decoding method as claimed in claim 7, wherein the hard coded is a BCH codec.

10. The joint encoding/decoding method as claimed in claim 7, wherein the soft codec is a LDPC codec.

11. The joint encoding/decoding method as claimed in claim 7, wherein the user data is decoded by the soft codec according to a hard-decision decoding method.

12. The joint encoding/decoding method as claimed in claim 7, wherein the user data is decoded by the soft codec according to a soft-decision decoding method.

13. A solid state drive, comprising:
plural flash memory modules; and
a memory controller connected with the plural flash memory modules, and comprising plural hard codecs correspond to the plural flash memory modules and a soft codec,
wherein a user data is encoded by one of the hard codecs and the soft codec of the memory controller to generate a first number of parity bits and a second number of parity bits respectively, wherein the user data, the first number of parity bits and the second number of parity bits are written into a corresponding one of the plural flash memory modules,
wherein during a data-reading process, the memory controller selectively uses the corresponding hard codec to decode the user data according to the first number of parity bits and/or uses the soft codec to decode the user data according to the second number of parity bits.

14. The solid state drive as claimed in claim 13, wherein the hard codecs are BCH codecs.

15. The solid state drive as claimed in claim 13, wherein the soft codec is a LDPC codec.

16. A joint encoding/decoding method for a solid state drive, the joint encoding/decoding method comprising steps of:
implementing a data-writing process for encoding a user data by a first encoding method and a second encoding respectively, thereby generating a first number of parity bits and a second number of parity bits;
writing the user data, the first number of parity bits and the second number of parity bits into a flash memory module; and
implementing a data-reading process for decoding the user data according to the first number of parity bits, wherein if the user data is successfully decoded, the user data is outputted, wherein if the user data is unsuccessfully decoded, the joint encoding/decoding method further comprises a step of decoding the user data according to the second number of parity bits.

17. The joint encoding/decoding method as claimed in claim 16, wherein after the step of decoding the user data according to the second number of parity bits is performed, the joint encoding/decoding method further comprises steps of:
if the user data is successfully decoded, outputting the user data; and
if the user data is unsuccessfully decoded, generating an initially-decoded user data, and then decoding the user data according to the initially-decoded user data and the first number of parity bits.
